(19) United States
(12) Patent Application Publication
(10) Pub. No.: US 2013/0156596 A1
(43) Pub. Date: Jun. 20, 2013

(54) Airfoil Design for Wakeless Wind Turbine Tower Structures

(71) Applicant: Richard Himmelmann, (US)

(72) Inventor: Richard Himmelmann, (US)

(21) Appl. No.: 13/329,609

(22) Filed: Dec. 19, 2011

(51) Int. Cl. F03D 11/04

(52) U.S. Cl. 416/244 R

(57) ABSTRACT

A novel wind turbine is provided that reduces or eliminates aerodynamic wake downwind of the tower to allow for the wind turbine to face away from the direction of the wind. The wind turbine comprises a tower and a rotor rotatably mounted to a nacelle which is mounted to the tower in stationary relationship therewith. The tower has a yaw bearing at its base so that it is rotatable about a vertical axis. In one embodiment the tower comprises a single airfoil symmetric about its major chord. In another embodiment the tower comprises a pair of spaced apart asymmetric airfoils defining a nozzle-like space there between through which a relatively high speed jet of air can travel to fill the aerodynamic wake zone behind the tower.

### FIELD OF THE DISCLOSURE

The present disclosure relates generally to wind turbines and, more particularly, to an improved design for wind turbine towers that reduces or eliminates aerodynamic wake downwind of the tower.

### BACKGROUND OF THE DISCLOSURE

A conventional wind turbine typically includes a set of two or three large blades mounted to a hub. The blades and the hub together are referred to as the rotor. Wind causes the rotor to rotate about a horizontal main shaft, which in turn is operatively connected via a speed increasing gear box to a generator or a set of generators that produce electric power. The main shaft, the gear box and the generator(s) are all situated within a nacelle, which is situated on top of a tower.

In recent years, engineers have designed wind turbines of all sizes and integrated them with electric power generation systems to create electricity to support the needs of both industrial and residential applications. As the wind power market has matured, there has been a large push to reduce the cost of energy (COE) of the electric power being produced by these wind turbine systems. The COE for a wind farm development is almost entirely driven by the manufacturing costs, assembly costs and maintenance costs of the wind farm itself, as there are no fuel costs associated with generation of electricity at the wind farm site. There are several large cost drivers associated with a wind farm site: (1) the tower, (2) the blades, (3) the speed increasing gear box, (4) the electric generator, (5) the power conditioning system and (6) the high power transmission lines that bring the wind farm electricity to the grid.

Existing tower designs typically have a predominantly circular cross section and are symmetric about their central vertical axis. This symmetry allows for the use of a fixed (non-rotating) tower, with a yaw bearing attaching the nacelle to the top of the tower. The yaw bearing allows the nacelle, and thus the blades, to rotate with respect to the tower so the blades can point into the wind regardless of wind direction. These symmetric, circular cross section towers have two distinct drawbacks.

First, circular cross section towers must be designed to react with the turbine's aerodynamic forces in any direction. Since the aerodynamic forces are predominantly along the wind direction, the symmetric design is non-ideal from a material usage standpoint. This use of extra material—typically steel—drives up the cost of the wind turbine.

Second, circular cross section towers create a pronounced “tower shadow effect.” The tower shadow effect refers to the aerodynamic wake that is present immediately downwind of the tower. In this aerodynamic wake zone, the wind velocity is dramatically reduced compared to the free stream (unencumbered) velocity. The tower shadow effect prohibits the use of a downwind turbine (one in which the blades are downwind of the tower), since the tower shadow effect momentarily unloads each blade as it passes through the aerodynamic wake zone. This momentary unloading of the aerodynamic force causes a loud audible noise to be generated. The noise is proportional to the magnitude of the tower shadow. In addition to the audible noise, the tower shadow effect also causes periodic force perturbations to impact the wind turbine system.

For these reasons, wind turbines having symmetrical, circular cross section towers operate pointing into the wind, with the blades upwind of the tower. Such wind turbines are referred to as “upwind wind turbines” or simply “upwind turbines.”

Another drawback to upwind turbines is that the blades must be rigid enough to ensure that they will not bend and strike the tower when subjected to high wind loads. Stiffer blades require more material to make, thereby increasing the cost of the wind turbine. Engineers have designed wind turbines in which the blades are set at a pitch (slight angle) off the vertical so that the distance between the blades and the tower is greatest when the blades are at their lowest point, but this solution has the disadvantage of reducing the wind driving force, and thus, electrical output.

Accordingly, it would be beneficial to provide a wind turbine tower that eliminates the tower shadow effect so that a downwind wind turbine could be utilized. The use of a downwind wind turbine would reduce the cost of the turbine system by allowing for lighter, more flexible blades, since the wind loads would tend to bend the blades away from the tower structure.

### SUMMARY OF THE DISCLOSURE

A novel wind turbine is disclosed. In a first embodiment of the invention, the wind turbine comprises a tower and a rotor having a hub and at least one blade. The rotor is rotatably mounted to a nacelle (along a horizontal axis of rotation), and the nacelle is mounted to the tower in stationary (fixed) relationship therewith. The tower has a top, a bottom, a height, a maximum thickness (width), and a yaw bearing at its base so that it is rotatable about a vertical axis.

In one embodiment of the invention referred to as the “single airfoil design”, the tower comprises a left side wall and a right side wall connected to each other along a rounded leading vertical edge and a relatively narrower trailing vertical edge to form a substantially hollow shell. The tower has a cross-sectional airfoil shape having a major chord extending from the leading vertical edge to the trailing vertical edge and a minor chord running perpendicular to the major chord and intersecting the major chord at the area of maximum tower thickness. The left and right side walls are curvilinear and symmetrical about the major chord. The length of the minor chord preferably is less than 50% that of the major chord, and may be less than about 33% that of the major chord. The maximum tower thickness may be smaller at the top of the tower than at the bottom of the tower.

In another embodiment of the invention referred to as the “twin airfoil design”, the tower comprises two separate, spaced apart airfoils. Each airfoil comprises a curved outer wall and a relatively flatter (less curved) inner wall connected along a rounded leading vertical edge and along a relatively narrower trailing edge. The inner walls are spaced apart and face each other. Each airfoil has a cross-sectional airfoil shape along all or a substantial portion of its height, with a major chord extending from the leading vertical edge to the trailing vertical edge and a minor chord running perpendicular to inner walls and intersecting the major chord at the area of maximum airfoil thickness. Each airfoil is asymmetrical about its major chord.

The twin airfoils are arranged symmetrically about a vertical plane and preferably are oriented at a slight angle of about seven degrees with respect to each other, with the leading edges farther apart than the trailing edges, so as to define a space there between through which a relatively high speed jet of air can travel to fill the aerodynamic wake zone behind the tower.

Other advantages and features will be apparent from the following detailed description when read in conjunction with the attached drawings.

### BRIEF DESCRIPTION OF THE DRAWINGS

For a more complete understanding of the disclosed apparatuses, reference should be made to the embodiments illustrated in greater detail on the accompanying drawings, wherein:

FIG. 1 is a perspective view of a conventional (prior art) wind turbine;

FIG. 2 is a graphic illustration of the wind speed surrounding a conventional wind turbine;

FIG. 3 is a front view of a wind turbine made according to the present invention;

FIG. 4 is a side view of a wind turbine made according to the present invention;

FIG. 5 is a cross sectional view of the wind turbine tower of FIG. 3 taken along line 5-5;

FIG. 6 is a graphic illustration of the wind speed surrounding the wind turbine of FIGS. 3 and 4;

FIG. 7 is a side view of a second embodiment of a wind turbine according to the present invention;

FIG. 8 is a front view of the wind turbine of FIG. 7;

FIG. 9 is a cross sectional view of the wind turbine tower of FIG. 7 taken along line 9-9 and excluding the base;

FIG. 10 is a partial close up view of the wind turbine of FIG. 7; and

FIG. 11 is a graphic illustration of the wind speed surrounding the wind turbine of FIG. 7.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

In the description that follows the term “chord” means a straight line connecting two points on a closed two dimensional shape and the term “major chord” means a straight line connecting the two points farthest apart on a closed two dimensional shape.

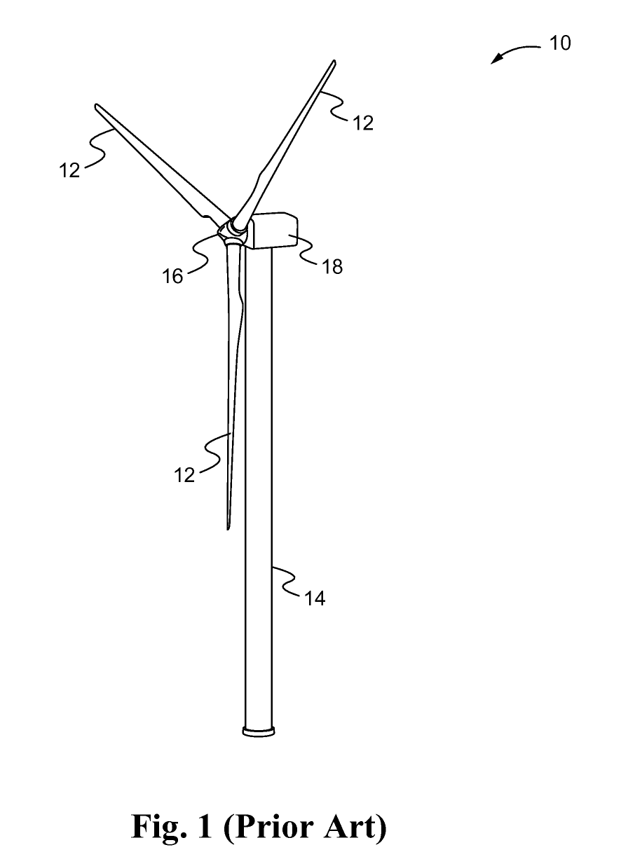

Referring now to FIG. 1, a conventional wind turbine 10 is shown. The conventional wind turbine 10 is an “upwind design”, meaning that the blades 12 operate upwind of the tower 14. The blades 12 are connected to a hub 16; together the blades 12 and the hub 16 are referred to as the rotor. The blades 12 rotate in response to wind, which is then translated into a driving torque by the rotor. The rotor is attached to and drives a main shaft, which in turn is operatively connected via a speed increasing gear box to a generator or a set of generators that produce electric power. The main shaft, the gear box and the generator(s) are all situated within a nacelle 18, which is rotatably mounted to the tower 14. The power generated by the generator(s) is transmitted down through the tower 14 to a power distribution system (not shown).

In addition to the components of the wind turbine 10 described above, the tower 14 may include several auxiliary components, such as a yaw system on which the nacelle 18 may be positioned to pivot and orient the rotor in a direction facing the prevailing wind current (and thus upwind of the tower 14) or another preferred wind direction, a pitch control unit (PCU) (not shown) situated within the hub 16 for controlling the pitch (e.g., angle of the blades with respect to the wind direction) of the blades 12, a hydraulic power system (not shown) to provide hydraulic power to various components such as brakes of the wind turbine, a cooling system (not shown) and the like.

The tower 14 shown is generally shaped like a circular cylinder having a constant diameter from top to bottom. Alternatively, many conventional towers are generally shaped like a circular cone having a larger diameter at the bottom than at the top. In either case conventional towers have a predominately circular cross section and therefore are substantially symmetrical throughout their height (vertical axis). This symmetry allows for the use of a fixed (non-rotating) tower, with a yaw bearing attaching the nacelle 18 to the top of the tower 14. The yaw bearing allows the rotor and nacelle 18 to rotate with respect to the tower 14 so the turbine 10 can always point into the wind.

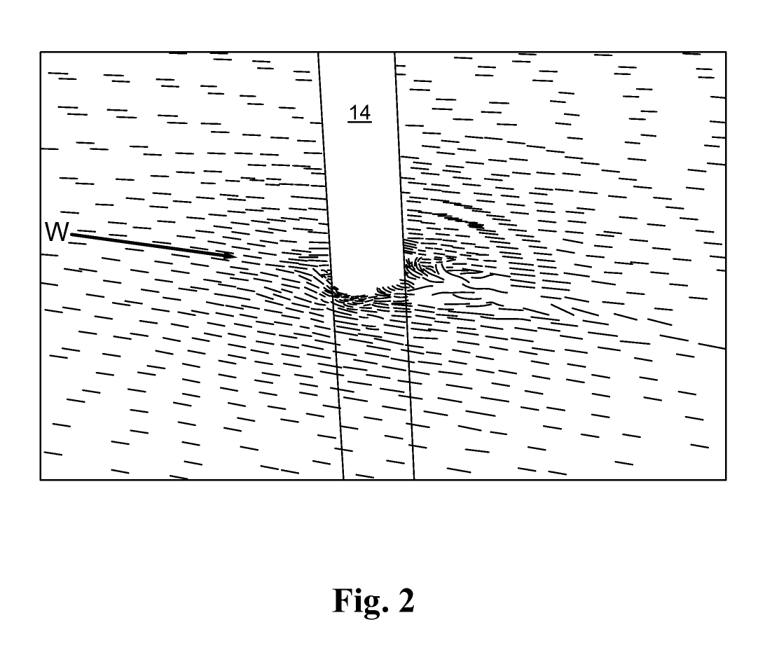

FIG. 2 is a graphic illustration of the wind speed surrounding a conventional wind turbine 10. At an average wind speed (free stream velocity) of 25 meters/second (m/s), the typical wind speed in the aerodynamic wake zone directly behind (downwind) the tower 14 can be as low as 1.31 m/s (shown graphically in FIG. 2 by the lack of wind vectors). This dramatic decrease in wind speed is referred to as the “tower shadow effect” and it prohibits the use of a downwind turbine, since the tower shadow effect momentarily unloads each turbine blade as it passes through the aerodynamic wake zone. This momentary unloading of the aerodynamic force causes a loud audible noise to be generated, which is proportional to the magnitude of the tower shadow. In addition to the audible noise, the tower shadow effect also causes periodic force perturbations to impact the wind turbine system.

The present invention is designed to eliminate the tower shadow effect so that a downwind turbine can be utilized. The use of a downwind turbine reduces the cost of the turbine system by allowing the designers to create lighter, more flexible, turbine blades, since upwind turbines require that the blades 12 be sufficiently rigid to ensure that they will not strike the tower 14 when subjected to high wind loads. With a downwind turbine, the wind loads tend to bend the blades away from the tower 14.

In accordance with this goal, the present invention is a new wind turbine design having a rotatable tower that incorporates a yaw bearing at the tower base, rather than at the top of the tower. By moving the yaw bearing from the top of the tower to the bottom of the tower, the entire tower structure is allowed to rotate along with the turbine and the nacelle, thereby maintaining the alignment of the tower with the nacelle/ turbine. By maintaining the alignment of the tower with the nacelle and rotor, a tower can be constructed with a smaller cross section in the direction normal to prevailing wind direction than the cross section parallel to the prevailing wind direction.

### First Embodiment

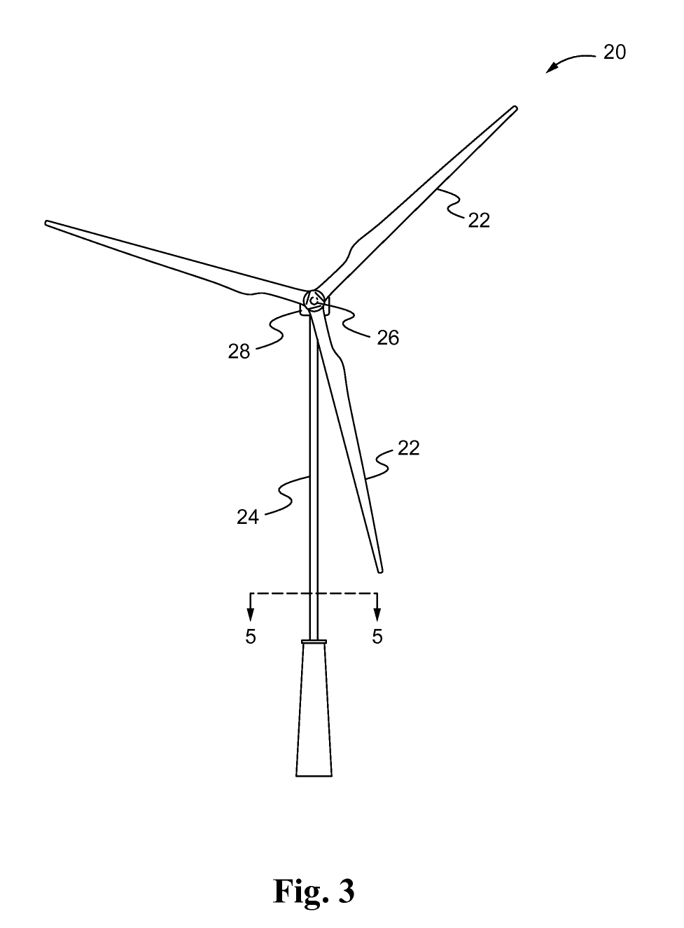

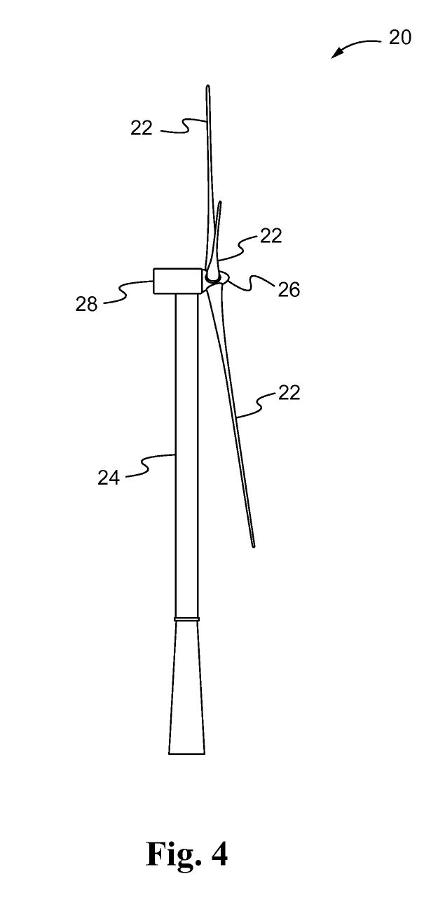

FIGS. 3 and 4 are front and side views of a wind turbine 20 made according to the present invention. Like the conventional wind turbine 10, this new wind turbine 20 comprises blades 22 connected to a hub 26, which in turn is connected to a nacelle 28, all of which is mounted atop a tower 24. However, in contrast to the conventional wind turbine 10, the tower 24 is an asymmetric, yawing (rotating) tower 24 that results in a substantially reduced tower shadow effect.

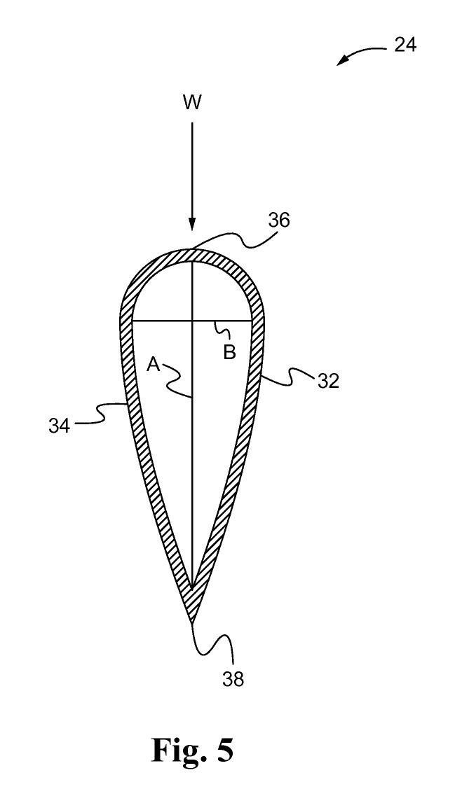

FIG. 5 is a cross sectional view of the wind turbine tower 24 of FIG. 4 taken along line 5-5. As shown in this cross sectional view, the tower 24 comprises left and right side walls 32, 34 connected along a vertical leading edge 36 and a vertical trailing edge 38 to form a substantially hollow shell. The left and right side walls 32, 34 are curved yet symmetrical about a major chord (A) and, therefore, form a symmetric airfoil. A minor (shorter) chord (B) is defined by a line running perpendicular to the major chord (A) and intersecting the major chord (A) at the area of maximum tower thickness (where the left and right side walls 32, 34 are farthest apart). The major chord (A) is also the camber line, defined as the locus of points midway between the left and right side walls 32, 34, and is straight.

The tower 24 cross section may be any suitable airfoil shape, but preferably is rounded in the area around the forward (wind) facing edge 36 and relatively narrower in the area around the trailing edge 38. The length of the minor chord B, i.e., the maximum thickness of the tower 24, is substantially less than the length of the major chord (A), i.e., the distance between the leading and trailing edges 36, 38, and preferably is less than 50% that of the major chord (A), and may be only about one third (⅓) the length of the major chord (A). In any case, the tower 24 is rotatable so that its smaller cross section (represented by minor chord (B)) is generally normal to the prevailing wind direction (W).

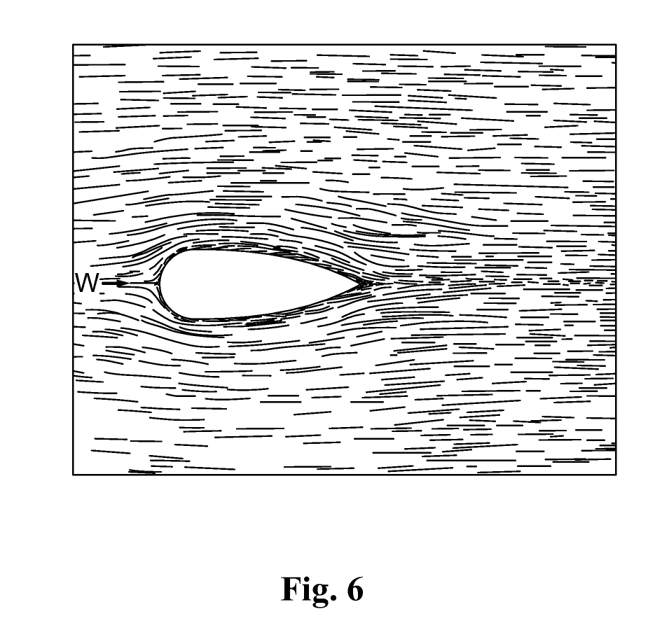

FIG. 6 is a graphic illustration of the wind speed surrounding the wind turbine of FIGS. 3-5. At an average wind speed (free stream velocity) of 25 m/s, the minimum wind speed in the aerodynamic wake zone directly behind (downwind) the tower 24 is still about 20 m/s, or about 80% of the free stream velocity. Although the symmetric airfoil shape of the tower 20 is capable of maintaining 80% wind speed behind the tower 20, the boundary layer effects on either side 32, 34 of the tower 20 create a stream of slower moving airflow directly behind the airfoil's rear stagnation point.

### Second Embodiment

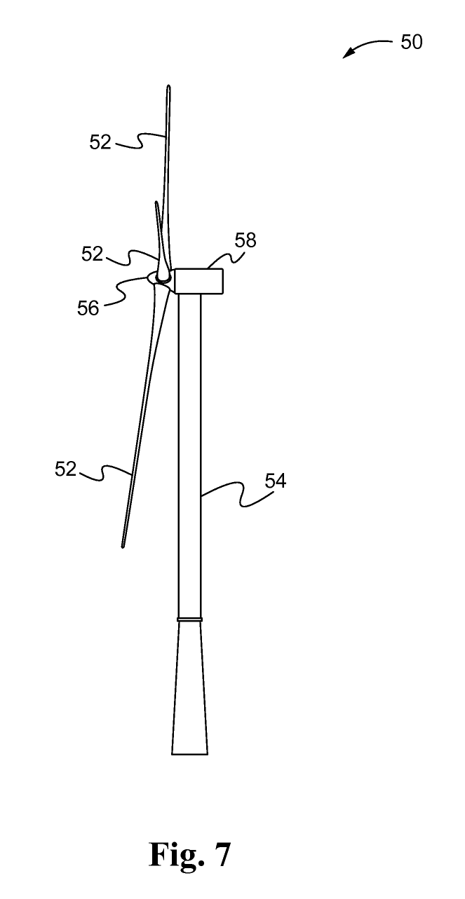

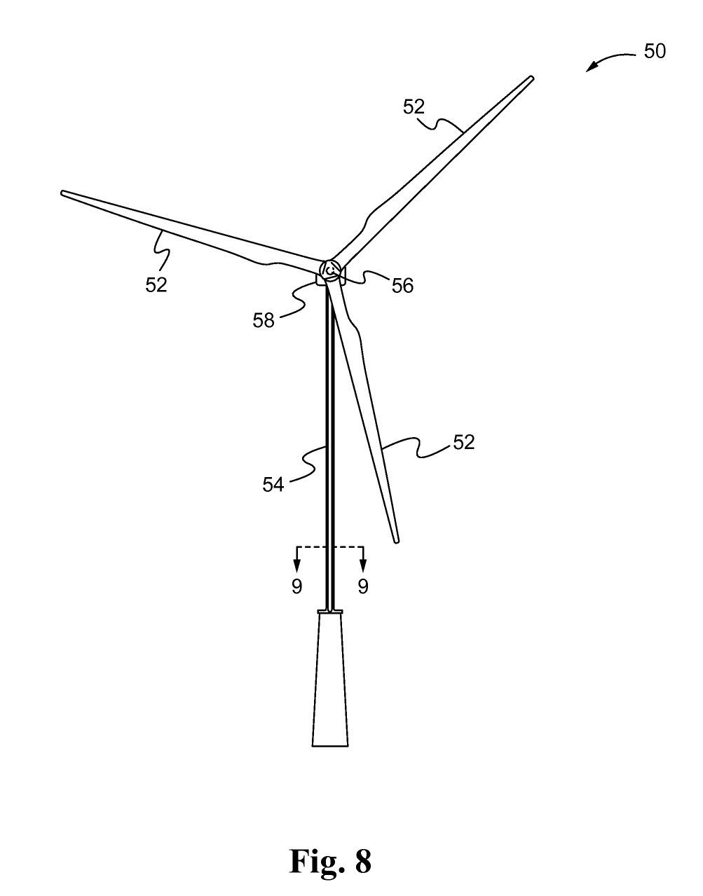

A second embodiment of the invention will now be described that also utilizes a full tower yawing system like the first embodiment. As shown in FIGS. 7 and 8, this second embodiment of a wind turbine 50 comprises blades 52 connected to a hub 56, which in turn is connected to a nacelle 58, all of which is mounted atop a tower 54.

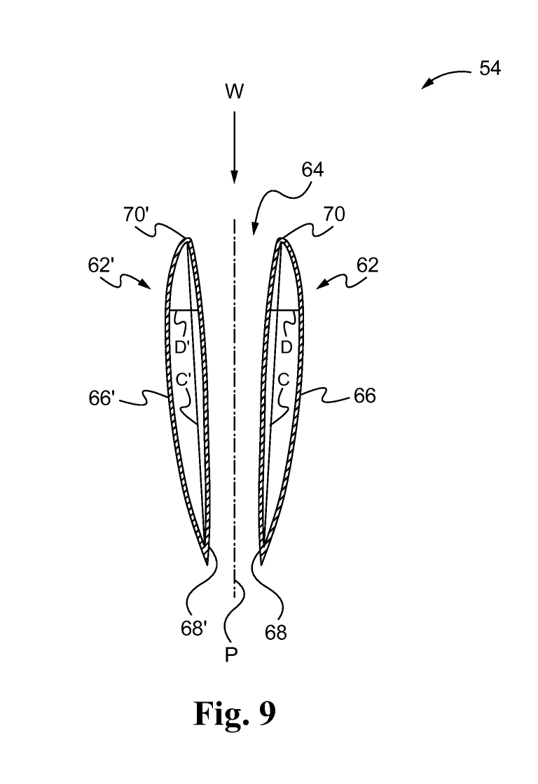

FIG. 9 is a cross sectional view of the wind turbine tower 54 of FIG. 7 taken along line 9-9. The tower 54 comprises two separate vertical supports or airfoils 62, 62′ that together form a nozzle 64 which delivers a relatively high speed jet of air to fill the aerodynamic wake zone created behind the tower 54.

Each airfoil 62, 62′ comprises an outer wall 66, 66′ and an inner wall 68, 68′ connected at a leading edge 70, 70′ and at a trailing edge 72, 72′ to form a substantially hollow shell. In contrast to the first embodiment, each airfoil 62, 62′ is asymmetrical about its major chord (C, C′), with one wall, the outer wall 62, 62′, being substantially more curved than the relatively flatter opposite (inner) wall 68, 68′.

A minor (shorter) chord (D, D′) is defined by a line running perpendicular to the inner walls 68, 68′ and intersecting the major chord (C, C′) at the area of maximum airfoil (and thus tower) thickness. While the major chord (C, C′) is by definition straight, the camber line, defined as the locus of points midway between the outer and inner walls, is curved. Each tower airfoil 62, 62′ may be any suitable airfoil shape, but preferably is rounded in the area around the forward (wind) facing edge 70, 70′ and relatively narrower in the area around the trailing edge 72, 72′.

As shown in FIG. 9, the length of the minor chord (D, D′) of each airfoil 62, 62′ is substantially less than the length of the major chord (C, C′), and preferably is less than 25% that of the major chord (C, C′), rendering each airfoil 62, 62′ almost fin-like in appearance. As the ratio of the length of the major chord (C, C′) to the minor chord (D, D′) increases, less material may be required.

The airfoils 62, 62′ are arranged symmetrically about a vertical plane (P). In operation the vertical plane (P) generally will coincide with (be parallel to) the prevailing wind direction (W). The angle defined by the major chords (C, C′) may be about seven degrees. As in the first (single airfoil) embodiment, the tower 54 is rotatable so that its smaller overall cross section is generally normal to the prevailing wind direction (W).

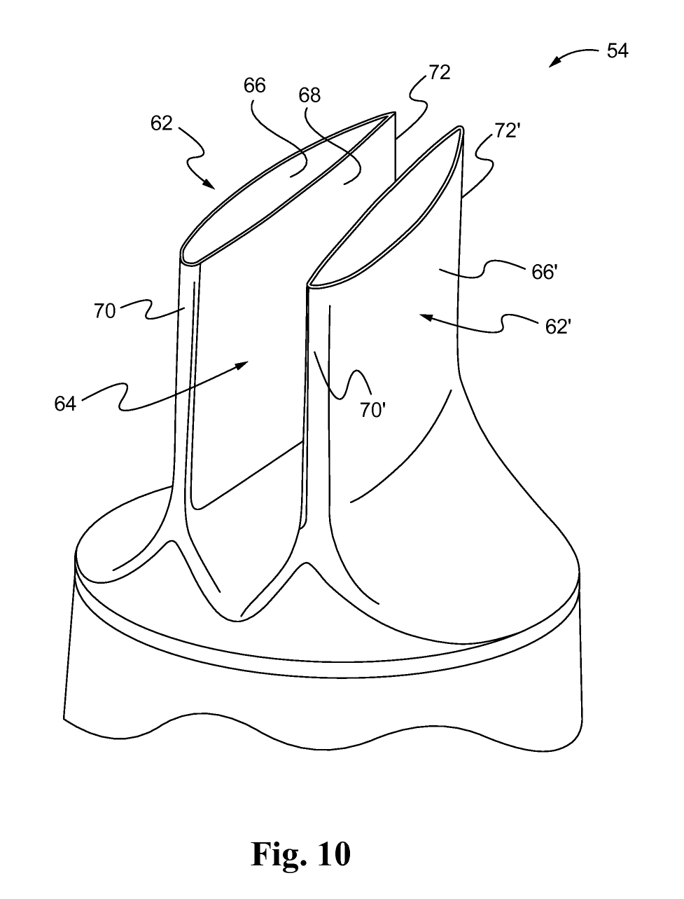

FIG. 10 is a partial close up view of the wind turbine of FIG. 7 near its base, showing the fin-like appearance of the twin airfoils 62, 62′. Further savings can be realized by manufacturing the inner walls 68, 68′ from lightweight composite materials while manufacturing the outer walls 66, 66′ from heavier weight load bearing material.

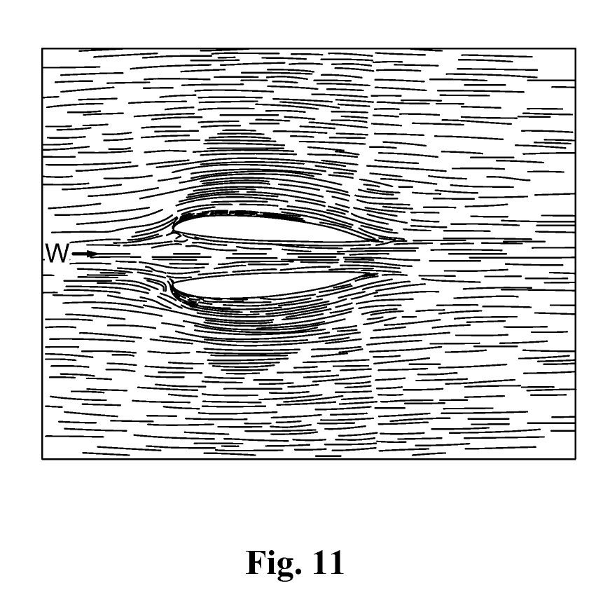

FIG. 11 is a graphic illustration of the wind speed surrounding the wind turbine of FIG. 7. At an average wind speed (free stream velocity) of 25 m/s, the minimum wind speed in the aerodynamic wake zone directly behind (downwind) the tower 54 is 23.43 m/s, or about 94% of the free stream velocity, almost the eliminating tower shadow effect.

The twin airfoil design of this second embodiment has two significant benefits. First, it eliminates or nearly eliminates the tower shadow effect, thereby reducing the acoustic signature of the wind turbine, and further reducing the structural perturbations being reacted by the turbine structures. Second, the twin airfoil tower 54 further reduces the mass of the tower, and therefore reduces the overall cost of the wind turbine 50. This may be accomplished by moving the two airfoil sections 62, 62′ away from one another, thereby increasing the effective width of the tower 54 without increasing its aerodynamic drag. As the effective width of the tower 54 is increased, the stresses on the tower 54 are proportionately lowered. Since the tower stresses are lower, the tower walls 66, 66′, 68, 68′ can be made with thinner materials, thereby lowering the overall tower mass and manufacturing costs.

I claim:

1. A downwind type wind turbine comprising:
a tower having a top, a bottom, a height, a maximum thickness, and a yaw bearing at its base so that it is rotatable about a vertical axis; and
a rotor having a hub and at least one blade, the rotor rotatably mounted to a nacelle, the nacelle mounted to the tower in stationary relationship therewith;
wherein the tower comprises a left side wall and a right side wall connected to each other along a rounded leading vertical edge and a relatively narrower trailing vertical edge to form a substantially hollow shell, the tower having a cross-sectional airfoil shape having a major chord extending from the leading vertical edge to the trailing vertical edge and a minor chord running perpendicular to the major chord and intersecting the major chord at the area of maximum tower thickness, the left and right side walls being curvilinear and symmetrical about the major chord.

2. The wind turbine of claim 1 wherein the length of the minor chord is less than 50% that of the major chord.

3. The wind turbine of claim 1 wherein the length of the minor chord is about 33% that of the major chord.

4. The wind turbine of claim 1 wherein the maximum tower thickness is smaller at the top of the tower than at the bottom of the tower.

5. A downwind type wind turbine comprising:
a tower having a top, a bottom, a height, a maximum thickness, and a yaw bearing at its base so that it is rotatable about a vertical axis, the tower having an aerodynamic wake zone located behind the tower; and
a rotor having a hub and at least one blade, the rotor rotatably mounted to a nacelle, the nacelle mounted to the tower in stationary relationship therewith;
wherein the tower comprises two separate, spaced apart airfoils, each airfoil comprising a substantially curved outer wall and a relatively flatter inner wall connected along a rounded leading vertical edge and along a relatively narrower trailing edge the inner walls being in substantially facing relationship to each other, each airfoil having a cross-sectional airfoil shape along a substantial portion of its height, each airfoil having a major chord extending from the leading vertical edge to the trailing vertical edge and a minor chord orthogonal to the inner walls and intersecting the major chord at the area of maximum airfoil thickness;
wherein the airfoils are arranged symmetrically about a vertical plane and define a space there between through which a relatively high speed jet of air can travel to fill the aerodynamic wake zone behind the tower.

6. The wind turbine of claim 5 in which each airfoil is asymmetrical about its major chord.

7. The wind turbine of claim 5 in which the airfoils are oriented at a slight angle with respect to each other with their leading edges farther apart than their trailing edges.

8. The wind turbine of claim 7 in which the airfoils are oriented with respect to each other at an angle of about seven degrees.

9. A wake reducing tower for a wind turbine having a rotor located downwind of the tower, the tower comprising:
a stationary base; and
a body section extending upward from and rotatably mounted to the base, the body section comprising two spaced apart vertical supports, each vertical support comprising a curved outer wall and an inner wall connected along a rounded vertical leading edge and a relatively narrower vertical trailing edge, the inner walls being in facing relationship to each other and defining a space there between through which a relatively high speed jet of air can travel to fill an aerodynamic wake zone behind the tower.

10. The wake reducing tower of claim 9 in which the body section has a first cross sectional dimension and a second cross sectional dimension orthogonal to and substantially larger than the first cross sectional dimension, and wherein the body section can be rotated so that its first cross sectional dimension is oriented in a direction normal to a prevailing wind direction.

11. The wake reducing tower of claim 9 wherein a substantial portion of the inner walls is made from a lightweight material and the outer walls are made from a relatively heavier weight load bearing material.
